(19) United States
(12) Patent Application Publication
(10) Pub. No.: US 2007/0205278 A1
(43) Pub. Date: Sep. 6, 2007

(54) Merchandise ordering system using a cell phone

(76) Inventor: Robert Lovett, Finger, TN (US)

Correspondence Address: JAMES RICHARDS, 58 BONING RD, FAYETTEVILLE, TN, 37334, US

(21) Appl. No.: 11/710,069

(22) Filed: Feb. 24, 2007

Related U.S. Application Data
(60) Provisional application No. 60/779,311, filed on Mar. 6, 2006.

(51) Int. Cl. G06K 15/00; G06Q 30/00

(52) U.S. Cl. 235/383; 705/15; 705/26

(57) ABSTRACT

A merchandise ordering system utilizing a cell phone for communicating order information and a Radio Frequency Identification (RFID) device for customer location and identification. Orders are placed using the cell phone prior to arrival at the retail establishment. RFID customer location information indicating proximity of the customer to the retail establishment is combined with the order information to execute the order. At order pickup, the RFID information or cell phone information may be used to identify the customer for delivery of the order. An automated call center may handle multiple retail establishments or multiple chains of retail establishments. A method is disclosed for placing orders using a block of phone numbers. In one embodiment, computer controlled order delivery trays are used to match the orders with the RFID tag supplied identification and deliver the order to the customer. When the order is delivered to the customer, the customer's credit card, debit card, or credit line may be charged according to prearrangements.

### RELATED APPLICATIONS

This application claims the benefit under 35 USC 19(e) of prior Provisional Application 60/779,311, “Merchandise Ordering Instrument,” filed Mar. 6, 2006, by Lovett, which is incorporated herein by reference in its entirety.

### FIELD OF THE INVENTION

This invention relates to the ordering of items to be prepared by a business operation, and more particularly to the placing of orders by cell phone before arriving at the business location.

### BACKGROUND OF THE INVENTION

U.S. Pat. No. 6,116,505 issued Sep. 12, 2000 to Withrow for FUEL TRANSACTION SYSTEM FOR ENABLING THE PURCHASE OF FUEL AND NON-FUEL TIMES ON A SINGLE AUTHORIZATION discloses a fueling transaction system the holds open a customer account after the pay-at-the-pump transaction is authorized in order that the customer may select non-fuel goods and services associated with a convenience store or restaurant to be charged to the same account. The initial customer account information or necessary identification may be provided by the customer's transponder in an RFID environment.

U.S. Pat. No. 6,529,880 B1 issued Mar. 4, 2003 to Mckeen et al. for AUTOMATIC PAYMENT SYSTEM FOR A PLURALITY OF REMOTE MERCHANTS discloses an automated payment system for a plurality or remote merchants including a clearinghouse server. The customer joining the clearinghouse service may be provided with an RFID transponder which stores an identification number to identify the customer to the system.

U.S. Pat. No. 6,073,840 issued Jun. 13, 2000 to Marion for FUEL DISPENSING AND RETAIL SYSTEM PROVIDING FOR TRANSPONDER PREPAYMENT, U.S. Pat. No. 6,089,284 issued Jul. 18, 2000 to Kachler et al. for PRECONDITIONING A FUEL DISPENSING SYSTEM USING A TRANSPONDER, U.S. Pat. No. 6,098,879 issued Aug. 8, 2000 to Terranova for FUEL DISPENSING SYSTEM PROVIDING CUSTOMER PREFERENCES, U.S. Pat. No. 6,422,464 B1 issued Jul. 23, 2002 to Terranova for FUEL DISPENSING SYSTEM PROVIDING CUSTOMER PREFERENCES, U.S. Pat. No. 6,470,233 B1 issued Oct. 22, 2002 to Johnson, Jr. for FUEL DISPENSING AND RETAIL SYSTEM FOR PREVENTING THE USE OF STOLEN TRANSPONDERS, and U.S. Pat. No. 6,574,603 B1 issued Jun. 3, 2003 to Dickson et al. for IN-VEHICLE ORDERING disclose an in-vehicle interface such as satellite or ground-based communication systems allowing occupants of a vehicle to place orders from within the vehicle for items provided by a quick-serve restaurant before the vehicle reaches a typical order entry position. The location of the vehicle may be monitored throughout the restaurant site by transponders including RFID transponders such that ordered items may be prepared and be available when the vehicle arrives at a pickup location.

U.S. Pat. No. 6,587,835 B1 issued Jul. 1, 2003 to Treyz et al. for SHOPPING ASSISTANCE WITH HANDHELD COMPUTING DEVICE discloses a system in which a handheld computing device provides a user with shopping assistance services. The handheld computing devices may be used to obtain information on products being sold in a store. Products may be purchased using wireless financial transactions.

U.S. Pat. No. 6,940,393 B2 issued on Sep. 6, 2005 to Dev et al. for SYSTEM AND METHOD FOR IMPROVED QUEUING, SERVICE-TIME, AND CAPACITY IN DRIVE-THROUGH OPERATIONS discloses a system and method of queuing orders which locates data-entry modules relative to a pickup location such that a customer who places an order after a customer who places an earlier order can be signaled to approach a pickup location before the first customer if the order of the second customer is ready before the order of the first customer.

U.S. Pat. No. 6,947,571 B1 issued Sep. 20, 2005 to Rhoads et al. for CELL PHONES WITH OPTICAL CAPABILITIES, AND RELATED APPLICATIONS discloses a cell phone and a variety of other arrangements by which electronic devices can interact with the physical world including RFID devices.

Innovation & Business Architectures, Inc., Breakthrough at the Drive-Through 26 Jul. 2004, discloses a call center which may be thousands of miles away from a participating McDonald's drive-through. At the call center, the operator takes your order and takes a digital picture of the customer in the car. The operator sends the information back to the people preparing the order at the restaurant. The system includes call-centers for walk-ins and call-centers for cell phones.

The prior art lacks a merchandise order system in which an order can be placed some distance from a store, and as the customer approaches the store, the customer is identified and the store to deliver the merchandise is selected. Thus the customer does not have to wait in a line such as a fuel delivery line before placing the order. If the store is a quick-serve restaurant, the kitchen of the restaurant can begin preparing the food order even before the customer arrives at the store such that when the customer arrives, the order is ready. The prior art also lacks a merchandise ordering system in which a customer, during the order process, selects the chain of stores from which the merchandise is to be delivered, and that only stores affiliated with the selected chain are identified for delivering the merchandise.

### SUMMARY OF THE INVENTION

Briefly, the present invention pertains to a merchandise ordering system utilizing a cell phone for communicating order information and a Radio Frequency Identification (RFID) device for customer location and identification. Orders are placed using the cell phone prior to arrival at the retail establishment. RFID customer location information indicating proximity of the customer to the retail establishment is combined with the order information to execute the order. At order pickup, the RFID information or cell phone information may be used to identify the customer for delivery of the order. An automated call center may handle multiple retail establishments or multiple chains of retail establishments. A method is disclosed for placing orders using a block of phone numbers. In one embodiment, computer controlled order delivery trays are used to match the orders with the RFID tag supplied identification and deliver the order to the customer. When the order is delivered to the customer, the customer's credit card, debit card, or credit line may be charged according to prearrangements.

In one embodiment, several city blocks before reaching the restaurant, a cell phone user activates the cell phone and selects the desired restaurant chain and selects the drive-through option. The user reviews the menu recorded in the cell phone and selects the desired food items. The order is confirmed, and the user activates the buy-now button. The cell phone places a call to the call-center and places the order with the restaurant chain without identifying a particular store. The user is identified by an RFID tag sensor which is placed a desired distance, for instance three to five city blocks from a participating restaurant. The sensed RFID tag identification is matched by the RFID tag identification and the cell phone number in the call-center's database. The call center then sends the order to the participating restaurant with the RFID identification of the customer. The participating store prints out the order with a barcode, and the order is assembled in the kitchen of the store and placed on a computer controlled food tray. When the user arrives at the pickup window, the customer is identified by a second sensor sensing the RFID tag, and the computer matches the customer with the order, and delivers the order to the customer with the automated food tray. When the customer picks up the order, the customer's account is charged, as prearranged. In one embodiment, cash-back may be delivered with the order.

It is thus a feature of one embodiment of the present invention to provide a merchandise ordering system which is fully automated by use of a cell phone for ordering merchandise, a call center for receiving the cell phone order and forwarding the order to a store, and an RFID tag read by RFID sensors for matching the order with the customer making the cell phone call and for identifying the store for delivering the merchandise to the customer.

It is a further feature of one embodiment of the present invention to provide a merchandise ordering system in which a customer ordering merchandise identifies a chain of stores for delivering the merchandise ordered, and in which only a store affiliated with the selected chain are identified for delivering the ordered merchandise to the customer.

It is a further feature of one embodiment of the invention to provide a call center which updates a menu in a cell phone such that the menu from which a customer orders through a cell phone is currently updated.

It is a further feature of one embodiment of the invention to provide a store which receives orders from a call center in which a customer's order is identified with an identification which may be matched with customer identification sensed with an RFID sensor for matching the customer with an order.

It is a further feature of one embodiment of the invention to provide an automated tray which is computer controlled for serving the order made by a customer to that customer as identified by RFID sensors.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a cell phone ordering system having a cell phone, a call center and a fast-food restaurant;

FIG. 2 present a flow chart of the order method of the system of FIG. 1;

FIG. 3 illustrates a customer account maintained in the call center of FIG. 1;

FIG. 4 illustrates a computer generated order sent from the call center to the restaurant in response to the customer's order;

FIG. 5 illustrates a ticket printed out by the system;

FIG. 6 presents a flowchart showing placement of an order from a cell phone to the call center;

FIG. 7 presents a flowchart of the call center receiving an order from the cell phone and sending the order to the restaurant;

FIG. 8 presents a flowchart of the restaurant receiving the order from the call center and delivering the order to the customer;

FIGS. 9-14 are examples of the menu for the restaurant stored in the cell phone of FIG. 1;

FIG. 15 illustrates telephone numbers used in one embodiment of the cell phone order system; and

FIGS. 16-18 illustrate embodiments of the food tray used in the system of FIG. 1.

The detailed description explains the preferred embodiments of the invention, together with advantages and features, by way of example with reference to the drawings.

### DETAILED DESCRIPTION OF THE INVENTION

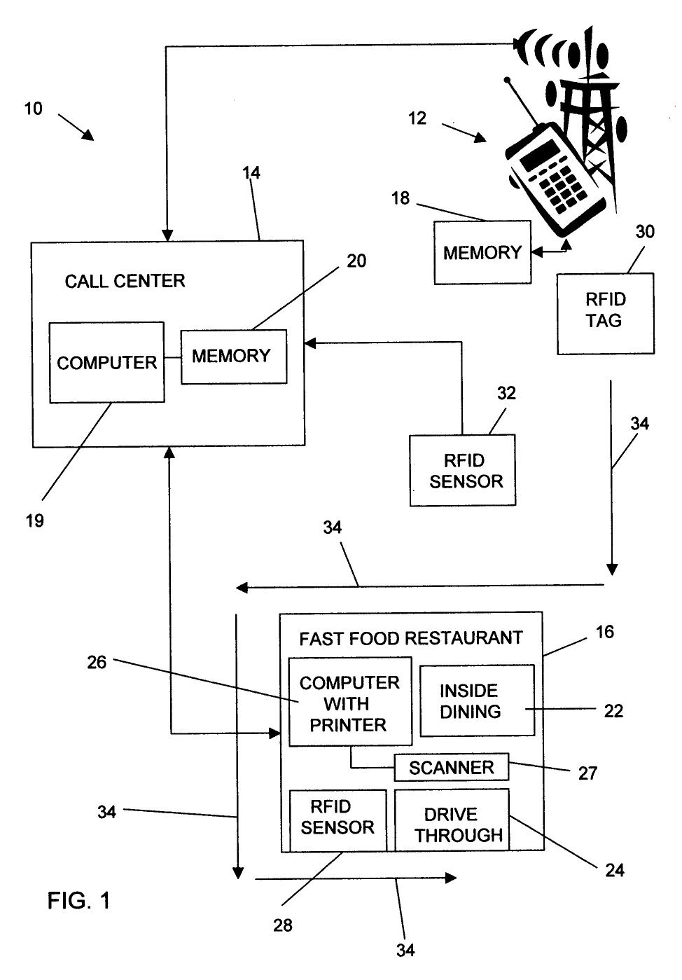

FIG. 1 illustrates an exemplary embodiment of the system 10 of the present invention which includes a cell phone 12, a call center 14, and a fast food restaurant 16. The cell phone 12 includes a memory 18 in which cell phone numbers, food menus and software programs to complete an order, which will be discussed. The call center 14 is, in one embodiment, computer controlled and includes a computer 19 having a memory 20 in which customer accounts are stored and which contains software programming to complete the order process of the present invention, which will be discussed. The fast food restaurant 16 includes an inside dining area 22, a drive through window 24, a computer 26 having a barcode printer scanner, a scanner 27 in the food service area of the drive through window 24, and an RFID scanner 28. The restaurant also includes an inside order area and a kitchen, which are not shown for simplicity. In close association with the cell phone 12 is an RFID tag 30. The RFID tag 30 may, for instance, be located in an automobile with the user of the cell phone for identifying the user of the system for placing an order, as will be discussed. Along the street approaching the restaurant 16 is an RFID sensor 32 for sensing the RFID tag 30. The arrows 34 identify the path of the automobile as the user places an order and approaches the restaurant for receiving the order. RFID transponders in tags and methods for reading them are well understood, and will not be discussed further. Although the present embodiment uses a restaurant as an example, it will be understood that any store or retail establishment may be used, and that the illustrated restaurant is an example only. Also, “customer” and “user” is used herein interchangeably. It will be understood that the cell phone 12 with its memory 18 and the RFID tag 30 together form a merchandise ordering instrument, whose use will be explained.

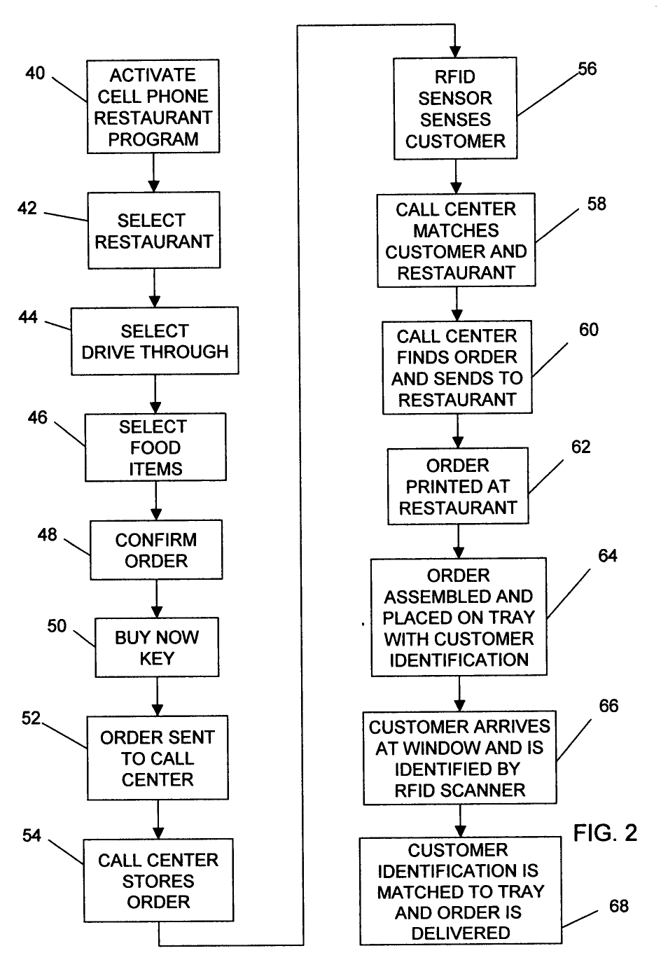

FIG. 2 provides a flowchart of the order method of the system of FIG. 1. At 40, the user activates the cell phone restaurant program stored in the memory 18 of the cell phone 12. The restaurant chain is selected by the user at 42, and at 44, the user selects whether the order is for the inside dining area 22 or the drive through window 24. At 46, the user selects the food items to be ordered. When all of the food items for this order have been ordered, the user confirms the order at 48. This may be done by a text read-out on the cell phone, or by an audio response to read back the items ordered. If the order is not correct, the user may correct the order. When the user is satisfied that the order is correct, at 50 the user activates a “buy now” key on the cell phone. At 52, the order is sent by the cell phone to the call center. At 54, the call center stores the order and identifies the user by the caller ID feature of the cell phone. To this point, the order has not been identified with a particular store or restaurant of the restaurant chain and is only stored as a tentative order. There is a time limit set, and if the order is not identified with a particular store of the restaurant chain, the order is deleted. Along the route 34 of the user on the way to the particular store 16, the user passes an RFID sensor 32 which senses the customer. This is shown at 56. The RFID tag number is then sent from the sensor 32 to the call center 14. At 58, the call center uses the RFID tag number to match the customer to the particular restaurant 16 associated with the sensor 32. At 60, the call center finds the order previously stored, and sends the order to the restaurant computer 26. It will be understood that the sequence could be reversed. In that event, when the sensor 32 senses the RFID tag, a tentative order is established, and the call center waits until an order is received associated with the RFID tag of the ordering customer. If an order is not received from that customer within a set time period, the tentative order is deleted.

At 62, the order from the call center is printed out at the restaurant. In one embodiment, the order that is printed out includes a bar code which identifies the customer who made the order. At 64, the order is assembled by the restaurant and placed on a tray with the customer identification. As the customer approaches the restaurant 16 on route 34, the customer arrives at the RFID sensor 28 in the restaurant. At 66, the customer is identified by the RFID scanner 28 and arrives at the drive through window 24. At 68, the customer identification is matched to the tray and the order is delivered. In one embodiment, a computer controlled food tray is used to match with the scanner 27, the barcode printed out at 62 with the tag number of the customer, and the food tray is automatically extended to deliver the ordered items to the customer. It is only after the food items are received that the customer's account is charged, as will be discussed.

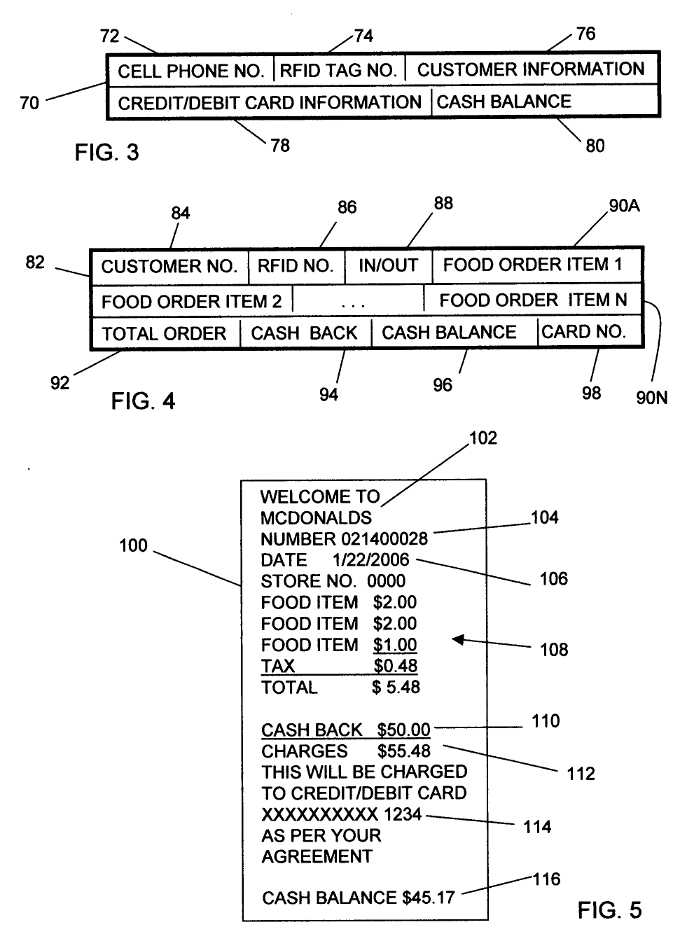

FIG. 3 is an illustration of the customer information kept in the memory 20 of the call center 14. The customer record 70 includes the cell phone number 72 of the cell phone 12 for identifying the customer by the caller ID number which accompanies the cell phone call to the call center. The customer record 70 also includes the RFID tag number 74 of the RFID tag which will be used by the sensors 32 and 28 to identify the customer. Further customer information 76 is included which may include the customers name, address and further account information, as desired. Also included is the credit card number or debit card number 78 which is authorized for accepting charges. In one embodiment, a cash balance 80 is kept in the customer record 70 for use in a cash-back embodiment. The cash balance 80 may be used, for instance, with a gift card. A cash gift may be given by, for instance, the parent or friend of the customer. The customer may then buy food items until the cash balance is used up. In one embodiment, the customer may request cash back in addition to the cost of the food, which cash back will be charged to the debit card account or the cash balance. Using the cash balance feature, a customer, for instance a young person or college student without a bank or credit cards, may place money in a call center's cash balance account from a restaurant which subscribes to the call center's service, and may withdraw cash by visiting any restaurant who subscribes to the call center's service and asking for cash back with a food order until the cash balance is exhausted.

FIG. 4 is an illustration of the order that is sent by the call center 14 to the restaurant 16. This may be done through a computer message from the computer 19 to the computer 26 or in the telephone call to the restaurant 16, as desired. Messaging between computers is well understood, and will not be described further. The order message 82 includes a customer number or name 84 to identify the customer, the RFID tag number 86 for identifying the RFID tag sensed by the sensor 28 for matching the order with the customer, an indication 88 for whether the order is for inside dining or the drive through window, and a list of food items 90a-90n. The order also indicates the total cost of the order 92, and cash back 94 to be delivered with the order, any cash balance 96 in the cash-back account after the order and/or cash back has been subtracted from the previous balance, and the credit card or debit card number 98.

FIG. 5 is an illustration of the sales receipt 100 delivered to the customer along with the order. The sales receipt 100 includes a salutary phrase 102 which may be tailored by the restaurant, the transaction number which may include the store number 104 and the date of the transaction 106, a list of the food items purchased, tax and total amount 108, the amount of cash back, if any, received 110, the total amount charged 112 for this sales receipt, the last four digits of the credit/debit card 114, and any cash balance 116 left in the cash account. A customer number or customer name may also be shown on the receipt, if desired. However, for security reasons, it is preferred that the sales receipt not identify the customer.

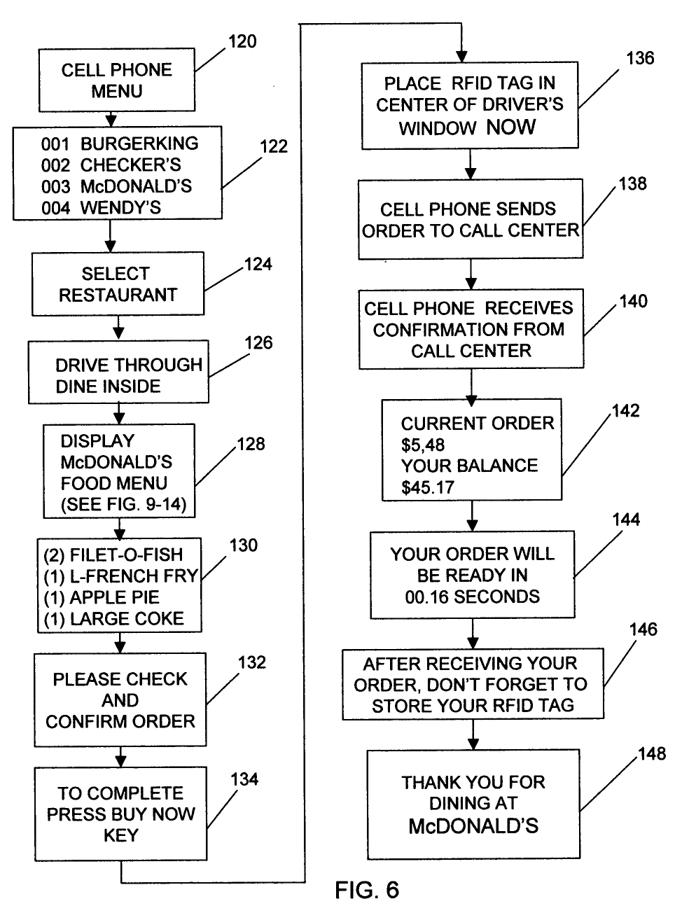

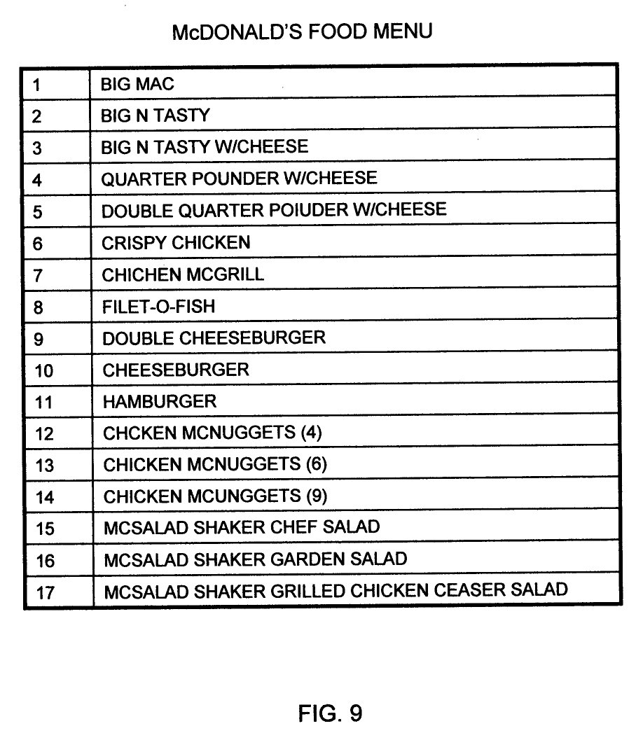

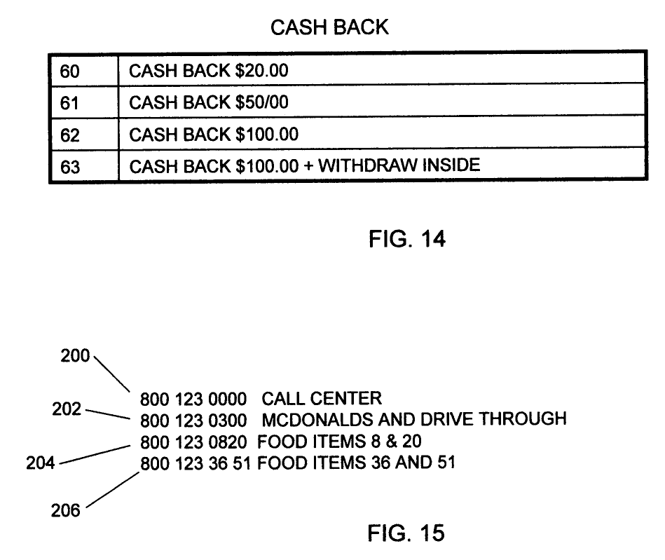

FIG. 6 presents a flowchart of the software restaurant ordering program in the call center 16 of FIG. 1. At 120, the cell phone, after activation of the program, a cell phone menu is presented. This menu is shown at 122 and is a list of fast food chains subscribing to the cell phone ordering service. At 124, the customer selects from the list, the restaurant desired. The program then presents selections shown at 126 such that the customer selects whether this is a drive-through order or a dine-inside order. At 128, the cell phone displays the food menu of the food items available at the selected restaurant as shown in FIGS. 9-14. The food menu may be previously stored in the memory 18 of the cell phone and updated periodically from the call center to all cell phones subscribing to a food ordering service. In another embodiment, prior to displaying the food menu at 128, the cell phone may call the call center, and the call center can download the food menu to be used. At 130, the customer selects the food items to be ordered and the quantity of each item ordered. At 132, the cell phone displays a message to check and confirm the order, and gives the customer a choice to change or correct the order before it is submitted to the call center. At 134, the cell phone instructs the customer to complete the order by pressing the “BUY NOW” key. After the customer has pressed the BUY NOW key, the cell phone instructs the customer at 136 to place the RFID tag in the center of the Driver's window NOW. In one embodiment, to prevent false orders from being transmitted to the call center, the customer's RFID tag is stored in a shield to prevent the RFID transponder from being read by an RFID sensor. The message of 136 reminds the customer to place the RFID tag in a position to be read by the sensor 32 of FIG. 1. At 138, the cell phone sends the order to the call center. After processing the order, the call center sends a message to the cell phone confirming the order. At 140, the cell phone receives a confirmation from the call center and at 142 displays the amount of the current order. If a cash account is being used, the cash balance in the customer's account is also displayed. If the customer selects cash-back as shown in FIG. 14, the amount of cash to be received is also displayed. In one embodiment, the time display is shown at 144 showing how long it will be before the order is ready to be picked up. At 146, a reminder is made to the customer to store the RFID tag after receiving the order. Since the RFID tag is used to identify the customer at the drive through window, the RFID tag should not be stored until after the order is picked up. At 148, a thank-you message is displayed.

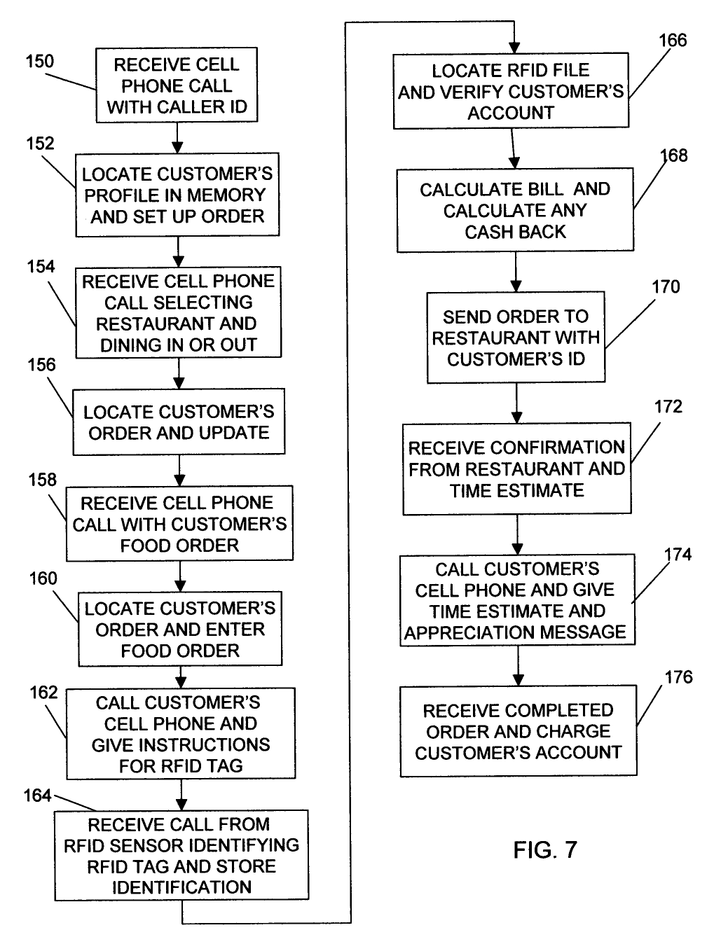

FIG. 7 is a flowchart of the food ordering program executed by the computer 19 of the call center 14 of FIG. 1. At 150, the call center receives a phone call from the cell phone 12. The phone call includes the caller ID of the cell phone. At 152, the call center 14 uses the caller ID number to locate the customer's profile in memory, and sets up the order. In one embodiment, at 154 the call center 14 receives a cell phone call selecting the restaurant and the dining in or drive through option. At 156, the call center locates the customer's order from the caller ID, and updates the order. At 158, the call center receives a phone call with the customer's food order, and at 160, using the caller ID, the customer's order is updated. In another embodiment, the calls as 150, 154 and 158 may be made in one phone call. The advantage is making three separate phone calls is that the calls may be very short instead of waiting for the complete order to be received. A single phone call may be quite lengthy waiting for the customer to select food items from a menu. At 162, the call center calls the customer's cell phone and sends the message at 136 instructing the customer to display the RFID tag.

At 164, the call center receives notification from the RFID sensor that the customer has been sensed on or near the premises of a restaurant. In one embodiment, the sensor is placed from three to five blocks from the restaurant. This notification at 164 is used to identify the particular store of the chain where the customer is going to pick up the order. At 166, using the RFID tag number, the customer's file is located and it is verified that the customer has placed an order using the customer's cell phone. At 168, the customer's bill is calculated and any cash back is calculated and approved.

At 170, the order is sent to the restaurant with the customer's ID. This ID may include the customer's name, the last four digits of the credit/debit card number, and the RFID tag number. At 172, the call center receives a confirmation from the restaurant 16 that the order has been received and a time estimate when the order will be ready for pick up. At 174, the call center calls the customer's cell phone and gives the time estimate shown in 144, and gives the appreciation message shown at 148. At 176, the call center receives a confirmation from the restaurant 16 that the order has been delivered, and the call center charges the customer's account.

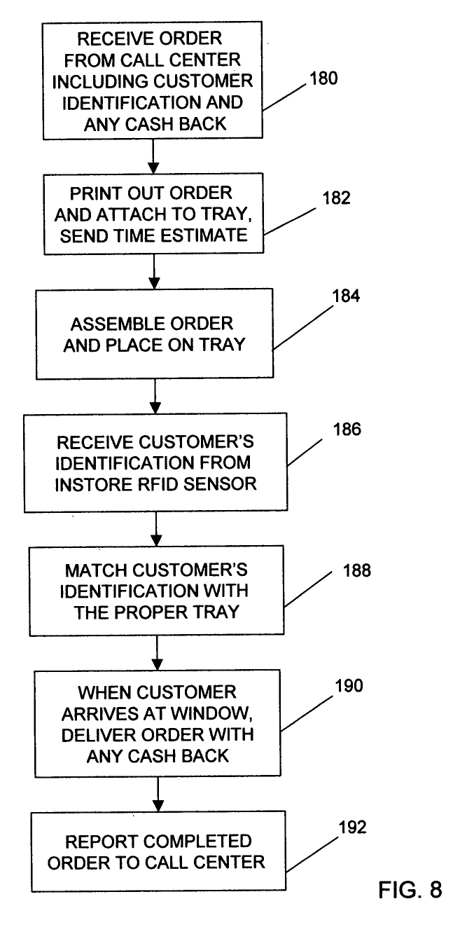

FIG. 8 presents a flowchart of the food ordering program for execution by the computer 26 in the restaurant 16 of FIG. 1. At 180, the restaurant receives an order from the call center, including the customer identification and any cash back to be delivered with the order. At 182, the restaurant prints out the order and attaches the order to a food tray. The printed order may include a barcode to identify the order to the computer, to be explained in connection with a description of the food tray. Also, the restaurant at 182 sends a time estimate to the call center to be sent to the customer at 174. At 184, the order is assembled on a food tray and readied for pick-up. At 186, the customer's identification is received from the instore RFID sensor 28. At 188, the proper food tray is matched up with the customer's identification. This may be done by a computer controlled food tray which would match the barcode with the customer's identification from the RFID tag number, or it may be done manually. At 190, when the customer arrives at the drive through window, the order is delivered, along with any cash back and the sales receipt of FIG. 5. Finally, the restaurant reports that the order is completed to the call center so that the customer's account may be charged at 176.

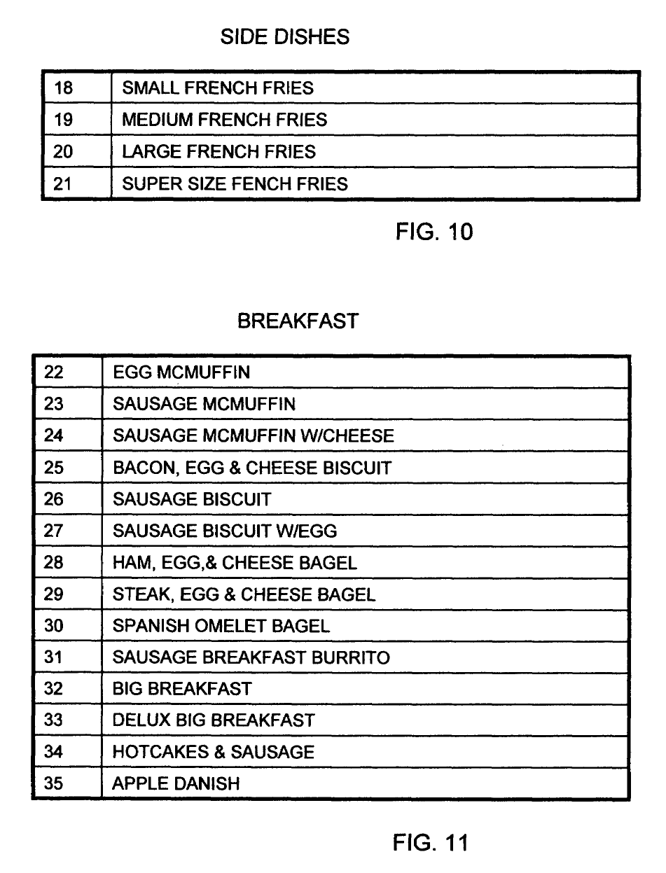

FIGS. 9-14 show one embodiment of the food item menus which are displayed at 128 of FIG. 6. For instance, if the restaurant selected is McDonald's Restaurants, the food menu of FIG. 9 is displayed. Each food item is identified by an item number which is used to order the item. FIG. 10 shows the side dishes which may be ordered, FIG. 11 shows the breakfast menu,

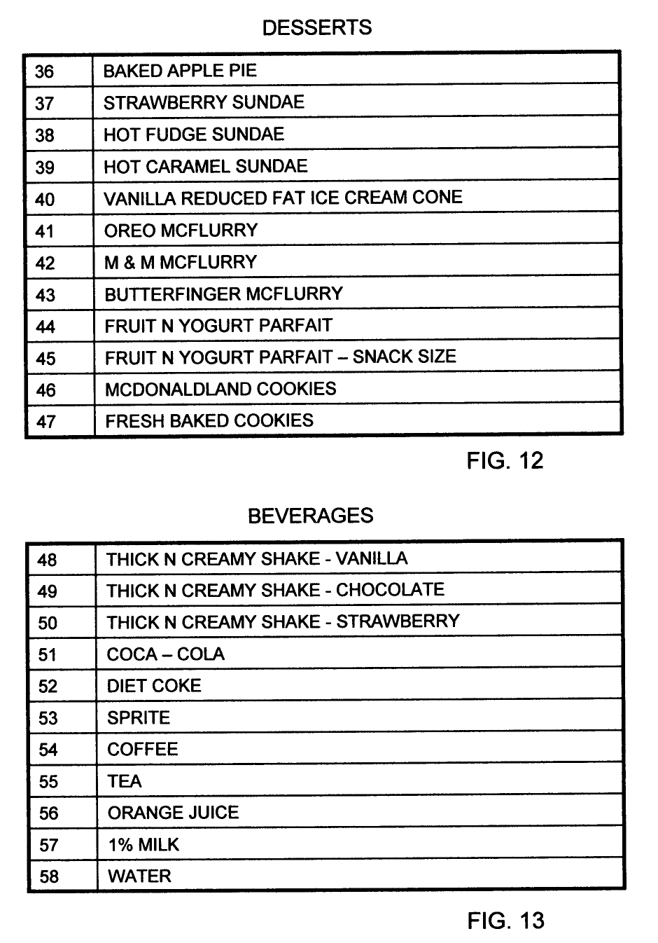

FIG. 12 shows the desserts menu, FIG. 13 shows the beverages menu, and FIG. 14 shows the cash back options. As mentioned, each selection is identified by an item number to be used in ordering items.

FIG. 15 shows one embodiment for placing calls to the call center by the customer's cell phone. In one embodiment, the phone number for the call center is a ten digit number. The first three digits indicate a toll free number, and may be, for instance, any 800 number. The next seven digits is the phone number for the call center. In one embodiment, digits 4, 5 and 6 indicate the call center, and thus reserves 10,000 phone numbers 0000 to 9999. At 200, the first phone number 800 123 0000 is the number for the call center and starts the order dialog between the cell phone and the call center. At 202, in the next call, the next three digits “123” reconnects to the call center, and digits 7-9 indicates the restaurant selected at 124, and digit 10 indicates drive through or inside dining (0 for drive through and 1 for inside dining). At 204, the next call reconnects to the call center and indicates the first two items ordered, food items 08 (FILET-O-FISH) and 20 (LARGE FRENCH FRIES). At 206, the next call again reconnects to the call center and indicates the next two food items ordered, food items 36 (BAKED APPLE PIE) and 51 (COCA COLA). A button, such as the * button, may be used to indicate that the order is complete to display the total order at 130, and the # button may be used as the “BUY NOW” key. It will be understood that the number combination are examples only, and that other combinations or keys may be used, as desired. As mentioned, a single phone call may be used to place an order, but the use of separate phone calls does not require that the call to the call center be long, and the phone calls by several cell phones placing orders may be handled by the call center in an interleaved fashion simultaneously.

It will be understood that the cell phone will dial each number and let the phone ring only for a sufficient number of rings to activate caller ID. The call center's computer will use the caller ID to detect each incoming call. The customer order will be placed based upon the numbers dialed by the customer from a lookup table at the call center for each restaurant number. The cell phone user can store this order under favorites such as Monday, Tuesday, etc. so future orders can be recalled from memory. Both the cell phone and the call center will automatically store the order under, for instance, 8888 so that when the customer does reorder the same menu in the future, the cell phone will only need to dial 8888 to speed up the order process. Two or more items that are frequently ordered together will also be stored in the cell phone and the call center's database. Afterwards, two items and three items in the database may constitute a complete order, which will save on the number of calls required to complete the total order. Most items are for a single item. If two or more are ordered, the number will be called a second time with the same item number and quantity. For instance, if the order is for two Filet-O-Fish sandwiches, the cell phone will dial 0820 one time for food items 08 and 20, and then call 0802 with the digits 9 and 10 being the total number of Filet-O-Fish sandwiches ordered, in this case 2. In the way a total number of Filet-O-Fish sandwiches in a single order may be up to 99. Thus, if two consecutive numbers are dialed for the same menu item, the second number is an order for that item joined with the number of that item to be in this order.

In one embodiment, the call center can send specials for breakfast, lunch, and dinner to each cell phone in the system daily. For instance, the numbers 800 000 5555 through 800 000 6666 might be reserved for daily specials.

As explained, each user will be issued an RFID tag containing a unique serial number which is connected to their cell phone and credit/debit/cash account at the call center to be used to pay for food purchases. This tag can be issued by any restaurant that subscribes to the service. When a tag is issued, the restaurant will require the cell phone number in order to send the order to the call center. Each time a user adds money to an account, the restaurant will run the RFID tag through a Point of Sale (POS) magnetic swipe terminal with the amount, which will be sent to the call center.

In one embodiment, when dinning inside the restaurant, the RFID tag will be placed on the table where the waiter will use a portable RFID reader to deliver the order to the proper location. If the user leaves the RFID in their automobile, then the user can show the last four digits of their credit card or cell phone display, which will also show the last four digits of the credit/debit card, as an alternate way to identify the user for delivery of the order by the waiter.

As previously explained, the user may be instructed to order food from three to five city blocks before arriving at the restaurant. After food has been ordered, the RFID tag will be placed in the driver's window with any RFI shielding removed. The user will pass by an RFID reader or sensor placed on the side of the street near the restaurant. The reader will automatically read each tag that has the RFI shielding removed as it passes the reader's location. Only the call center can interpret this unique number and connect the number to a cell phone number and payment account number.

In the foregoing example, the user has selected a McDonald's restaurant to dine at, however the user may pass another restaurant (for example, Wendy's restaurant) using the same system before reaching the restaurant of choice. An RFID reader stationed outside the Wendy's restaurant will read the RFID tag on the user's window and send the unique number form the tag to the call center. The call center will recognize reader as being for Wendy's restaurant. The call center will look in the Wendy's database for the number sent by the Wendy's RFID reader. Since the number is not in the Wendy's database, the call center will ignore the request from Wendy's restaurant.

When the user approaches the McDonald's restaurant, the RFID reader will also interrogate the user's RFID tag and send it to the call center. The call center will recognize that the RFID reader is for the McDonald's restaurant and will look in the database for McDonald's restaurant for the RFID tag number to find an outstanding order.

The call center will now find the order placed earlier in the McDonald's database and will send that order to the computer at the McDonald's restaurant. The McDonald's computer will print out the order in the kitchen for processing. The printout will contain the complete order plus a barcode, which contains the RFID serial number and the last four digits of the credit/debit card. This printout will be used when the user picks up the order at the drive through window or inside the restaurant. The restaurant now has a complete history of all incoming calls from the call center which may be used to analyze the traffic from the call center.

After the order has been assembled and ready for pickup, the barcode scanner at the drive through window will read the barcode and send it to the restaurant's computer. The computer will look at the RFID reader with is stationed outside the drive through window and compare the barcode to the RFID tag, and if there is a match, allows the order to be given to the user. Since the order was paid by credit/debit/cash card on file at the call center, no money will be exchanged, unless a cash-back option is selected.

If the user should pass by a McDonald's restaurant after placing an order, the RFID tag on the other side of the restaurant will read the tag and send a cancellation to the original restaurant where the order was placed. This might happen, for instance, from time-to-time because there could be an emergency after the order was placed, or the user might simply just forget.

If a user has a credit line, that user can get cash from any restaurant that subscribes to the call center service using a cash-back option. In the disclosed embodiment, only three cash back amounts are used to make the transaction easier. In one embodiment, larger amounts require an inside transaction.

If a friend or child should need emergency money, an account may be set up or cash added to cash accounts at any participating restaurant. In one embodiment, the donating user would go to any participating restaurant, and give the attendant the ten-digit cell phone number of the recipient and the dollar amount to be added to the recipient's account. The attendant contacts the call center and enters the ten-digit cell phone number and confirms that the recipient has an account, and then enters the dollar amount to be added to the recipient's cash account.

Within a few seconds, the recipient can collect money, minus any transaction fees, from any participating restaurant at any global location. As a second level of security, the recipient may be required to enter the restaurant and place a call to the restaurant attendant. This gives the attendant the opportunity to see the caller ID of the recipient's phone number, which must match the barcode phone number of the order asking for cash back.

Many young employees have no banking connection. Many times, such employees must use check cashing businesses which charge for their services and may have limited business hours. By depositing the employee's paycheck directly into a participating restaurant's cash account for the employee, the employee may withdraw their cash from the cash account at any restaurant while they are getting lunch. This has the advantage that a participating restaurant would not have to print and distribute checks to their employees but only deposit the pay into an employee's cash account.

In addition, by using cash accounts, a user does not need to take traveler's checks when going on vacation. Instead, the user can deposit money into a cash account which may be withdrawn in any participating restaurant world wide.

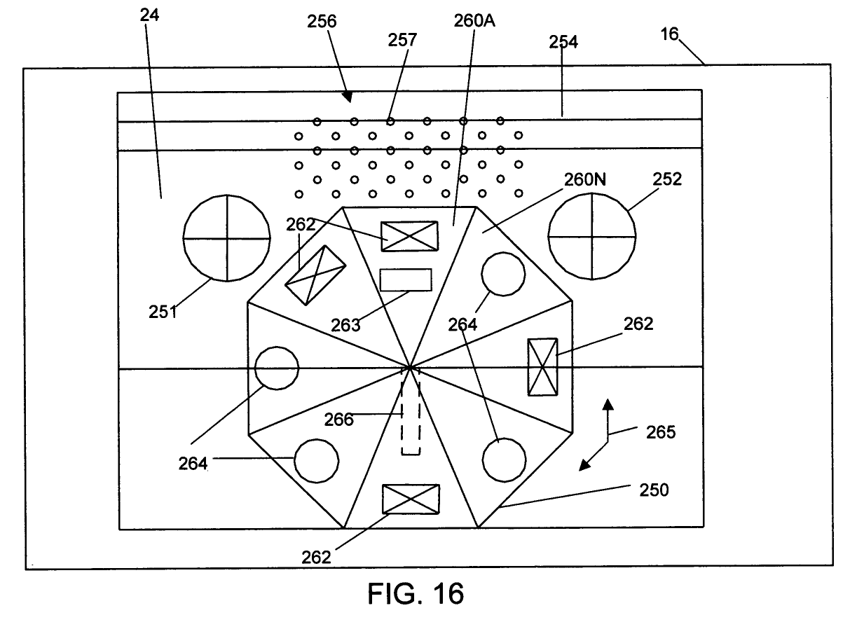

FIGS. 16, 17, and 18 illustrate embodiments of a food tray usable with the present invention. FIG. 16 shows a segmented food tray 250 in the drive through window 24 of the restaurant 16. The drive through window 24 may be protected by protection poles 251 and 252. The drive through window is approached by a customer by a drive through lane 254. The front of the window 24 may include a light curtain 256 made up of a plurality of individual light sources 257 paired with light sensors, not shown, usable such that when a customer approaches in an automobile, the light screen 256 can sense the exact location of the automobile in relation to the food tray 250. The food tray is divided into segments 260A-260N in which food items 262 and 264 may be placed. Items 262 represent sacks of food items and 264 represent liquids such as drinks in cups. A hydraulic or pneumatic cylinder 266 is used to extend the proper food segment or segments to the side of the automobile for easy removal by the customer. The food tray is rotatable as shown at 265, by the computer 26, or if desired a separate computer, to the proper segment 260 for delivery of the ordered food items to the customer. How far the food tray segment is extended is determined by the light screen 256 which, as explained, senses the exact location of the customer's automobile in the drive through lane 254. The tag printed out by the computer printer of 26 includes a bar code. The order bar code 263 is placed in the food tray segment 260, and the scanner 27 is used to scan the bar code on the tag such that the food tray 250 may be rotated to the proper segment. If more than one segment is needed, more barcode tags may be printed, or the number of trays may be entered into the computer 26 when the food items are placed into the food tray 250.

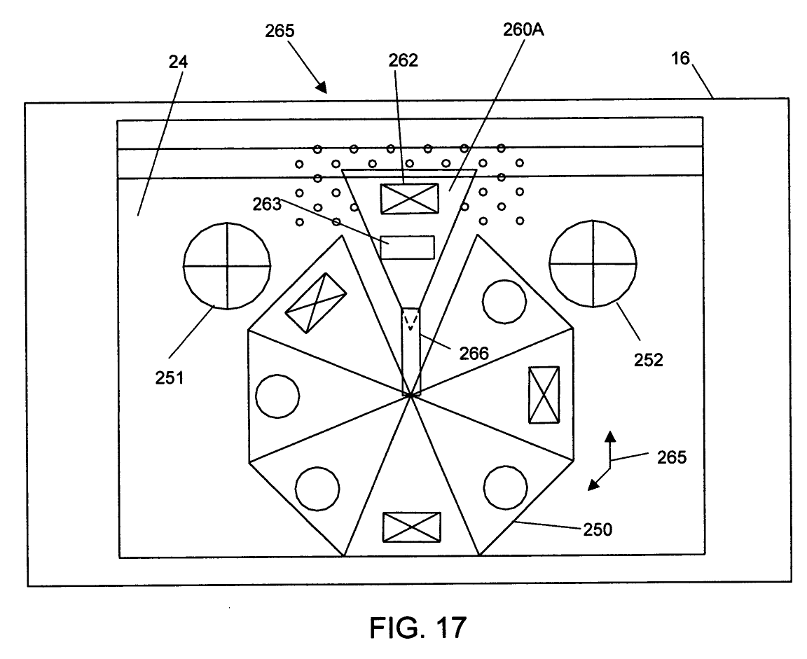

FIG. 17 illustrates the food tray 250 of FIG. 16 with the food tray segment 260A extended by the cylinder 266. The food tray segment 260A is extended between the poles 251 and 252 by the distance into the drive through lane 254 as determined by the light curtain 256. In one embodiment, the segments in which the food items of the order are placed are selected by the computer 26. Any cash back may be delivered to the customer by an attendant in the drive through window, or may be included on a food tray segment, as desired. The sales receipt may be printed out by a printer at the drive through window, or may be included in the food item bag 262, as desired.

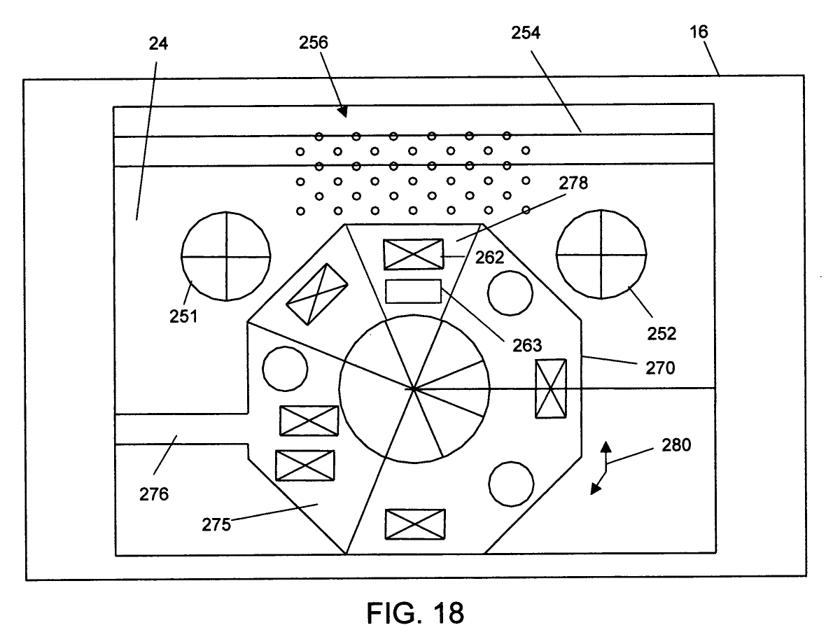

FIG. 18 illustrates another embodiment 270 of the food tray. The food tray 270 of FIG. 18 includes a refrigerated compartment 275 which is connected to refrigeration equipment in the restaurant 16 by a refrigeration duct 276. The segments 278 of the tray 270 may include a bar code tag 263, or may be rotatable by hand or by computer as shown at 280, such that perishable items in the refrigeration unit may be rotated for access by the customer, as desired.

It will be understood, that the present invention may be used with General Packet Radio Service (GPRS) systems or other packet switching technologies. In such systems, packet switched data is used rather than circuit switched data. This technology makes more efficient use of available capacity because data transfers in packets in, what is often referred to as a “bursty” fashion. Thus, data in transferred in short peaks, followed by breaks when there is little or no activity. Data packets for one recipient may be interspersed with data packets for other recipients, and switched to the proper recipients at switching locations. Thus, the data in an order may be divided into packets, with each packet containing elements of an order. A call to the call center thus may contain packets from several different callers, with the calls separated out to the proper caller's phone numbers using packet switching techniques. Thus, it will be understood that a single call may be made from a packet device to the call center, with the single call containing all of the elements of an order without tying up the line to the call center because packets from several other callers may be received simultaneously.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A merchandise order processing system comprising:
a call center comprising:
a cell phone communication receiver for receiving an order from a customer, said order communicated by using a cell phone;
a location receiver for receiving location information for said customer from a location determination device;
a processor for associating said order and said location information with a customer identification number; and
an order transmitter for sending said order and said customer identification number to a selected retail establishment, said retail establishment selected based on said location information for said customer;
said selected retail establishment comprising:
an order receiver for receiving said order and said customer identification number from said order transmitter; and
a customer identifying device for determining said customer identification number from said customer at a delivery location so that merchandise may be delivered to said customer in accordance with said order.

2. The merchandise order processing system in accordance with claim 1 wherein the location determination device comprises an RFID device.

3. The merchandise order processing system in accordance with claim 1 wherein the customer identifying device comprises an RFID device or a caller ID device.

4. The merchandise order processing system in accordance with claim 1 wherein the customer identification number is an RFID serial number or a cell phone number.

5. The merchandise order processing system in accordance with claim 1 wherein the location determination device is placed to detect said customer prior to arrival of said customer at said retail establishment.

6. The merchandise order processing system in accordance with claim 5 wherein said location determination device is placed three to five city blocks from said retail establishment.

7. The merchandise order processing system in accordance with claim 1 wherein said selected retail establishment is within a franchise group of retail establishments.

8. The merchandise order processing system in accordance with claim 1 further including an account for said customer associated with said call center, wherein said account is billed after delivery of said merchandise.

9. The merchandise order processing system in accordance with claim 1 wherein one aspect of said order is determined by said cell phone receiver receiving said cell phone on a particular phone number from a group of possible phone numbers.

10. An automated call center for use in a merchandise ordering system, said call center comprising:
a cell phone call receiver for receiving an order placed over a cell phone by a customer;
a memory for storing said order received by said cell phone call receiver, said order including a first identification of the customer placing said order;
a position-identifier receiver for receiving a second identification of the customer, said position-identifier receiver located near a store such that the customer is identified by said position-identifier receiver before the customer arrives at said store;
a first matching routine for matching the first identification of the customer with the second identification of the customer; and
an order transmitter for sending said order and said second identification of the customer to said store such that said store may deliver merchandise to said customer in accordance with said order.

11. The call center according to claim 10 wherein the second identification of the customer is a Radio Frequency Identification tag number.

12. The call center according to claim 10 further comprising a memory including an account to which said order is to be charged.

13. The call center according to claim 10 wherein said order received at said cell phone call receiver includes an indication of a chain of stores to which said order is directed, and said order transmitter sends said order to said store only if said store is affiliated with said chain of stores.

14. The call center according to claim 10 wherein said store comprises:
an order receiver for receiving said order and said second identification of the customer from said order transmitter;
an identification sensor for sensing a third identification of the customer as the customer arrives at said store; and
a second matching routine for matching the second identification of the with the third identification of the customer, thereby allowing said merchandise to be delivered to said customer in accordance with said order.

15. The call center according to claim 14 wherein said second identification of the customer and said third identification of the customer are Radio Frequency Identification tag numbers.

16. An automated order handling method comprising:
receiving a cell phone communication at a call center from a customer, said cell phone communication including an order for merchandise and a first identification of the customer;
determining a location of the customer and a second identification of the customer prior to said customer arriving at a store;
associating said first identification of the customer and said order with said second identification of the customer;
selecting said store based on said location of the customer; and
transmitting said order and said second identification of the customer from said call center to said store.

17. The order handling method according to claim 16 wherein the location of the customer is determined by using a Radio Frequency Identification transponder.

18. The order handling method according to claim 16 further comprising the steps of:
calling said cell phone from said call center, said calling including the step of
updating a menu for said store stored in said cell phone.

19. The order handling method according to claim 18 wherein the step of receiving a cell phone communication comprises the step of:
receiving a series of calls from said customer, wherein at least one call of said series of calls includes said first identification of the customer and another call of said series of calls includes an identification of at least one item selected from said menu.

20. The order handling method according to claim 19 wherein another call of said series of calls includes an indication of a chain of stores to which said order is directed, further including the step of:
disregarding a position determination that is not associated with said chain of stores.
